(19) United States
(12) Patent Application Publication
(10) Pub. No.: US 2025/0124084 A1
(43) Pub. Date: Apr. 17, 2025

(54) DETECTING AND ANALYZING INFLUENCE OPERATIONS

(71) Applicant: Norwich University Applied Research Institutes, Ltd., Northfield, VT (US)

(72) Inventors: Mark Perry, Warren, VT (US); Rachel Sickler, Montpelier, VT (US); John W. Kidder, Barre, VT (US); William T. Morris, Northfield, VT (US)

(21) Appl. No.: 18/916,167

(22) Filed: Oct. 15, 2024

Related U.S. Application Data
(60) Provisional application No. 63/544,306, filed on Oct. 16, 2023.

(51) Int. Cl. G06F 16/9035; G06F 16/908

(52) U.S. Cl. CPC G06F 16/9035; G06F 16/908

(57) ABSTRACT

Methods and systems for detecting influence operations are provided. In some examples, methods include receiving a plurality of content items, and providing each content item of the plurality of content items to a primary machine-learning model which is trained to determine whether one or more content items are associated with one or more predefined influence operations. The method further includes receiving, from the primary machine-learning model, an indication that at least one content item of the plurality of content items is associated with the one or more predefined influence operations, and providing the at least one content item to at least one secondary machine-learning model which is trained to determine whether one or more content items are associated with one or more predefined diverse narratives for the one or more predefined influence operations. In some examples, each predefined diverse narrative corresponds to a diagnostic frame and/or a prognostic frame.

### CROSS REFERENCE TO RELATED APPLICATIONS

This application claims priority to U.S. Provisional Application No. 63/544,306, entitled “DETECTING AND ANALYZING INFLUENCE OPERATIONS,” and filed on Oct. 16, 2023, which is incorporated by reference herein for all purposes in its entirety.

### BACKGROUND

This disclosure relates generally to detecting and analyzing influence operations, and more specifically to labelling diverse narratives of content items from at least one internet source. Some conventional techniques for analyzing information, such as information from content items, include sentiment analysis. For example, information may have negative sentiment and be associated with an influence operation. However, information may instead have positive sentiment and still be associated with an influence operation, while being undetected by sentiment analysis. Accordingly, there exists a need for improved techniques for analyzing information to determine if a content item is associated with an influence operation, and if so, what is the influence operation.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to methods, systems, and media for detecting and analyzing influence operations.

In some examples, a method for detecting influence operations is provided. The method includes receiving a plurality of content items from at least one internet source, and providing each content item of the plurality of content items to a primary machine-learning model. The primary machine-learning model is trained to determine whether one or more content items are associated with one or more predefined influence operations. The method further includes receiving, from the primary machine-learning model, an indication that at least one content item of the plurality of content items is associated with the one or more predefined influence operations, and providing the at least one content item to at least one secondary machine-learning model. The at least one secondary machine-learning model is trained to determine whether one or more content items are associated with one or more predefined diverse narratives for the one or more predefined influence operations. The method further includes receiving, from the at least one secondary machine-learning model, an indication of one or more predefined diverse narratives that are associated with one or more content items of the at least one content item, and providing an output based on the indication of one or more predefined diverse narratives.

In some examples, the one or more predefined influence operations each correspond to a respective influence entity.

In some examples, the plurality of content items include one or more long-form content items.

In some examples, training the primary machine-learning model includes: aggregating a plurality of training content items, labelling each training content item of the plurality of training content items to be associated with a respective one or more predefined or new influence operations, and outputting the plurality of training content items with corresponding indications of the associated one or more predefined or new influence operations.

In some examples, training the at least one secondary machine-learning model includes: aggregating a plurality of training content items, labelling each training content item of the plurality of training content items to be associated with a respective one or more predefined diverse narratives, and outputting the plurality of training content items with corresponding indications of the associated one or more predefined diverse narratives.

In some examples, each predefined diverse narrative of the one or more predefined diverse narratives correspond to one or more selected from the group of: a diagnostic frame and a prognostic frame.

In some examples, prior to providing the at least one content item to at least one secondary machine-learning model, the at least one content item is converted to text, and the text is provided to the at least one secondary machine-learning model.

In some examples, prior to providing each content item of the plurality of content items to a primary machine-learning model, a language of at least one content item of the plurality of content items is identified, and the primary machine-learning model is selected from a plurality of machine-learning models, based on the identified language of the at least one content item.

In some examples, a system for detecting influence operations is provided. The system includes a processor and memory storing instructions that, when executed by the processor, cause the system to perform a set of operations. The set of operations includes: receiving a plurality of content items from at least one internet source, and providing each content item of the plurality of content items to a primary machine-learning model. The primary machine-learning model is trained to determine whether one or more content items are associated with one or more predefined influence operations. The set of operations further includes receiving, from the primary machine-learning model, an indication that at least one content item of the plurality of content items is associated with the one or more predefined influence operations, and providing the at least one content item to at least one secondary machine-learning model. The at least one secondary machine-learning model is trained to determine whether one or more content items are associated with one or more predefined diverse narratives for the one or more predefined influence operations. The set of operations further includes receiving, from the at least one secondary machine-learning model, an indication of one or more predefined diverse narratives that are associated with one or more content items of the at least one content item, and providing an output based on the indication of one or more predefined diverse narratives.

In some examples, the one or more predefined influence operations each correspond to a respective influence entity.

In some examples, the plurality of content items include one or more long-form content items.

In some examples, training the primary machine-learning model includes: aggregating a plurality of training content items, labelling each training content item of the plurality of training content items to be associated with a respective one or more predefined or new influence operations, and outputting the plurality of training content items with corresponding indications of the associated one or more predefined or new influence operations.

In some examples, training the at least one secondary machine-learning model includes: aggregating a plurality of training content items, labelling each training content item of the plurality of training content items to be associated with a respective one or more predefined diverse narratives, and outputting the plurality of training content items with corresponding indications of the associated one or more predefined diverse narratives.

In some examples, each predefined diverse narrative of the one or more predefined diverse narratives correspond to one or more selected from the group of: a diagnostic frame and a prognostic frame.

In some examples, prior to providing the at least one content item to at least one secondary machine-learning model, the at least one content item is converted to text, and the text is provided to the at least one secondary machine-learning model.

In some examples, prior to providing each content item of the plurality of content items to a primary machine-learning model, a language of at least one content item of the plurality of content items is identified, and the primary machine-learning model is selected from a plurality of machine-learning models, based on the identified language of the at least one content item.

In some examples, a method for identifying diverse narratives is provided. The method includes receiving a plurality of content items from at least one internet source, and providing at least one content item of the plurality of content items to a plurality of narrative machine-learning models. The plurality of narrative machine-learning models are trained to determine whether one or more content items are associated with one or more predefined diverse narratives. Each predefined diverse narrative of the one or more predefined diverse narratives correspond to one or more selected from the group of: a diagnostic frame and a prognostic frame. The method further includes receiving, from the plurality of narrative machine-learning models, an indication of one or more predefined diverse narratives that are associated with one or more content items of the at least one content item, and providing an output based on the indication of one or more predefined diverse narratives.

In some examples, training the plurality of narrative machine-learning models includes: aggregating a plurality of training content items; labelling each training content item of the plurality of training content items to be associated with a respective one or more predefined diverse narratives; and outputting the plurality of training content items with corresponding indications of the associated one or more predefined diverse narratives.

In some examples, prior to providing the at least one content item to a plurality of narrative machine-learning models, the at least one content item is converted to text, and the text is provided to the plurality of narrative machine-learning models.

In some examples, the plurality of content items include one or more long-form content items.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 illustrates an overview of an example system according to some aspects described herein.

FIG. 2 illustrates an example method, according to some aspects described herein.

FIG. 3 illustrates an example method, according to some aspects described herein.

FIG. 4 illustrates an example table, according to some aspects described herein.

FIG. 5 illustrates an example plot, according to some aspects described herein.

FIG. 6 illustrates an example flow, according to some aspects described herein.

FIG. 7 illustrates an example flow, according to some aspects described herein.

FIG. 8 illustrates an example plot, according to some aspects described herein.

FIG. 9 illustrates an example plot, according to some aspects described herein.

FIG. 10 illustrates an example table, according to some aspects described herein.

FIG. 11 illustrates an example table, according to some aspects described herein.

FIG. 12 illustrates a block diagram illustrating example physical components of a computing device with which aspects of the disclosure may be practiced.

FIG. 13 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents. Further, throughout the disclosure, the terms “about”, “substantially”, and “approximately” mean plus or minus 5% of the number that each term precedes. For example, about 100 may mean 100+/−5.

Aspects of the present disclosure relate to the design, training, testing, and implementation of a supervised machine learning (ML) framework for analyzing influence operations (e.g., influence operations occurring online, such as over the Internet, via radio, via television, via podcasts, etc.). In some examples, the ML framework can be used with any language (e.g., spoken and/or written languages).

According to some specific examples provided herein, the language is Russian. For example, in a particular use-case, mechanisms (e.g., systems, methods, and/or media) provided herein may be used for analysis of the Russian Federation's information war against Ukraine, such as before and/or after the Russian Federation's invasion of Ukraine in February 2022. However, those of ordinary skill in the art should recognize that mechanisms provided herein may be used in accordance with any language of a plurality of different potential languages. Further, mechanisms provided herein may be used to identify influence operations being executed by any of a plurality of different persons, organizations, entities, or the like (e.g., businesses, clubs, countries, non-profits, etc.).

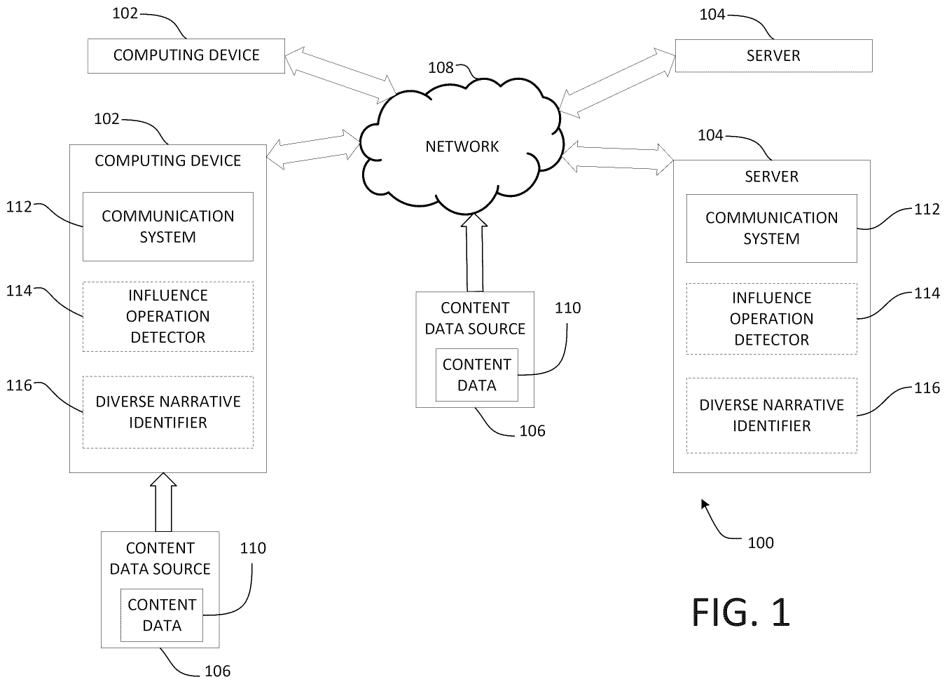

FIG. 1 shows an example of a system 100, in accordance with some aspects of the disclosed subject matter. The system 100 may be a system for detecting influence operations. Additionally, or alternatively, the system 100 may be a system for identifying diverse narratives (e.g., that are associated with influence operations). For example, diverse narratives may be different or varying narratives, such as may be used to advance an influence or marketing campaign. In some examples, the diverse narratives may include different content and/or rhetoric, with respect to each other, while promoting a particular point of view, set of values, and/or objective. The system 100 includes one or more computing devices 102, one or more servers 104, a content data source 106, and a communication network or network 108. The computing device 102 can receive content data 110 from the content data source 106, which may be, for example a database, a repository, a computer-executed program that generates content data 110, and/or memory with data stored therein corresponding to content data 110. The content data 110 may include a blog post, a news page, an article, and/or another type of content item that may be retrieved from an internet source. Additional and/or alternative types of content data may be recognized by those of ordinary skill in the art.

Additionally, or alternatively, the network 108 can receive content data 110 from the content data source 106, which may be, for example a database, a repository, a computer-executed program that generates content data 110, and/or memory with data stored therein corresponding to content data 110. The content data 110 may include a blog post, a news page, an article, and/or another type of content item that may be retrieved from an internet source. Additional and/or alternative types of content data may be recognized by those of ordinary skill in the art.

Computing device 102 may include a communication system 112, an influence operation detector 114, and/or a diverse narrative identifier 116. In some examples, computing device 102 can execute at least a portion of the influence operation detector 114, such as to determine whether one or more content items are associated with one or more predefined influence operations. In some examples, influence operations include campaigns (e.g., by individuals, businesses, organizations, agencies, countries, etc.) to spread diverse narratives to influence an audience.

Further, in some examples, computing device 102 can execute at least a portion of the diverse narrative identifier 116, such as to determine with which of a plurality of predefined diverse narratives a content item is associated. In some examples, a content item may be associated with a single diverse narrative. In some examples, a content item may be associated with a plurality of diverse narratives.

Server 104 may include a communication system 112, an influence operation detector 114, and/or a diverse narrative identifier 116. In some examples, server 104 can execute at least a portion of the influence operation detector 114, such as to determine whether one or more content items are associated with one or more predefined influence operations. In some examples, influence operations include campaigns (e.g., by individuals, businesses, organizations, agencies, countries, etc.) to spread diverse narratives to influence an audience.

Further, in some examples, server 104 can execute at least a portion of the diverse narrative identifier 116, such as to determine with which of a plurality of predefined diverse narratives a content item is associated. In some examples, a content item may be associated with a single diverse narrative. In some examples, a content item may be associated with a plurality of diverse narratives.

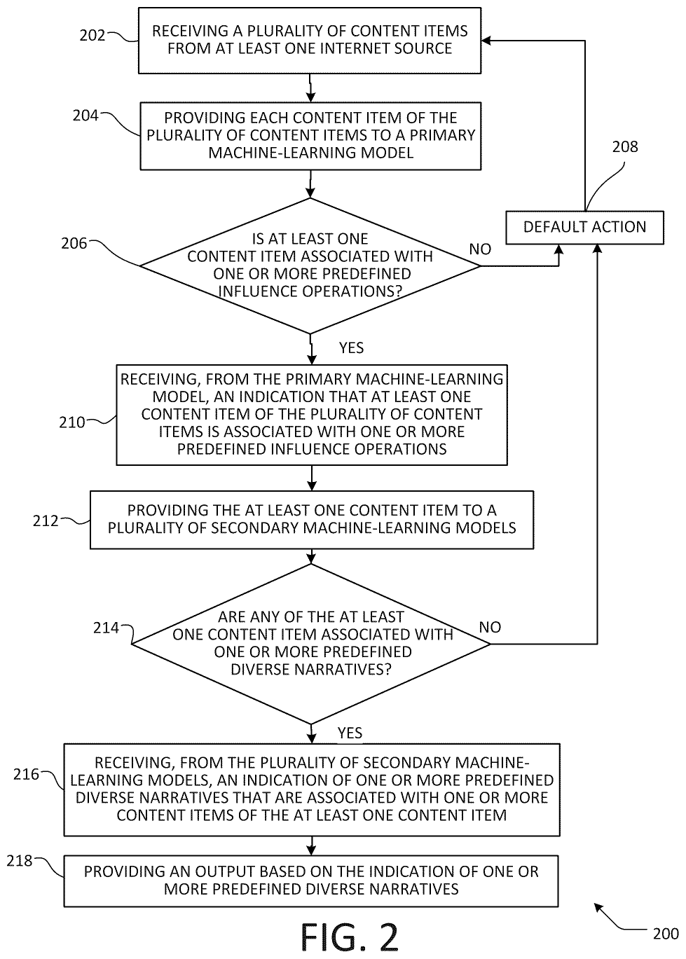

Additionally, or alternatively, in some examples, server 104 can communicate data received from content data source 106 to the server 104 over a communication network 108, and the server 104 can then execute at least a portion of the influence operation detector 114 and/or the diverse narrative identifier 116. In some examples, the influence operation detector may execute one or more portions of flows/methods/processes 200 and/or 300 described below in connection with FIGS. 2 and/or 3, respectively. Further in some examples, the diverse narrative identifier may execute one or more portions of flows/methods/processes 200 and/or 300 described below in connection with FIGS. 2 and/or 3, respectively.

In some examples, computing device 102 and/or server 104 can be any suitable computing device or combination of devices, such as a desktop computer, a vehicle computer, a mobile computing device (e.g., a laptop computer, a smartphone, a tablet computer, a wearable computer, etc.), a server computer, a virtual machine being executed by a physical computing device, a web server, etc. Further, in some examples, there may be a plurality of computing device 102 and/or a plurality of servers 104.

In some examples, content data source 106 can be any suitable source of content data, such as a database or repository for a blog, a news station, a publisher, a social media, an augmented reality environment, a virtual reality environment, etc. In some examples, content data source 106 can include memory storing content data (e.g., local memory of computing device 102, local memory of server 104, cloud storage, portable memory connected to computing device 102, portable memory connected to server 104, etc.). In some examples, content data source 106 can include an application configured to generate content data. In some examples, content data source 106 can be local to computing device 102. Additionally, or alternatively, content data source 106 can be remote from computing device 102 and can communicate content data 110 to computing device 102 (and/or server 104) via a communication network (e.g., communication network 108). In some examples, where the content data source 106 is remote from the computing device 102, the content data source 106 is physically distant from the computing device 102. It should be recognized that being remote from the computing device 102 does not necessarily require being miles apart from the computing device 102, but rather, in some examples, the content data source 106 can be as close as next to the computing device 102 and still be remote from the computing device 102 (e.g., via a connection through the communication network 108).

In some examples, communication network 108 can be any suitable communication network or combination of communication networks. For example, communication network 108 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, communication network 108 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

FIG. 2 illustrates an example method 200 for detecting influence operations, according to some aspects described herein. In examples, aspects of method 200 are performed by a device, such as computing device 102 and/or server 104, discussed above with respect to FIG. 1.

Method 200 begins at operation 202, wherein a plurality of content items are received. In some examples, the plurality of content items are received from at least one internet source. The at least one internet source may be the same or similar as the content data sources 106 discussed earlier herein with respect to FIG. 1. In some examples, the at least one internet source is a plurality of internet sources. In some examples, the plurality of content items may correspond to the content data 110 discussed earlier herein with respect to FIG. 1. For example, the plurality of content items may include one or more selected from the group of: articles, blog posts, news stories, short-form messages, video files (e.g., short-form videos), image files and/or text descriptions thereof, audio files and/or text transcriptions thereof (e.g., radio). Examples of long-form content items may include articles, blog posts, and/or news stories. In some examples, at least one content item of the plurality of content items may be in English. In some examples, at least one content item of the plurality of content items may be in a language other than English, such as Russian, Mandarin Chinese, Spanish, etc. Additional and/or alternative languages will be recognized by those of ordinary skill in the art.

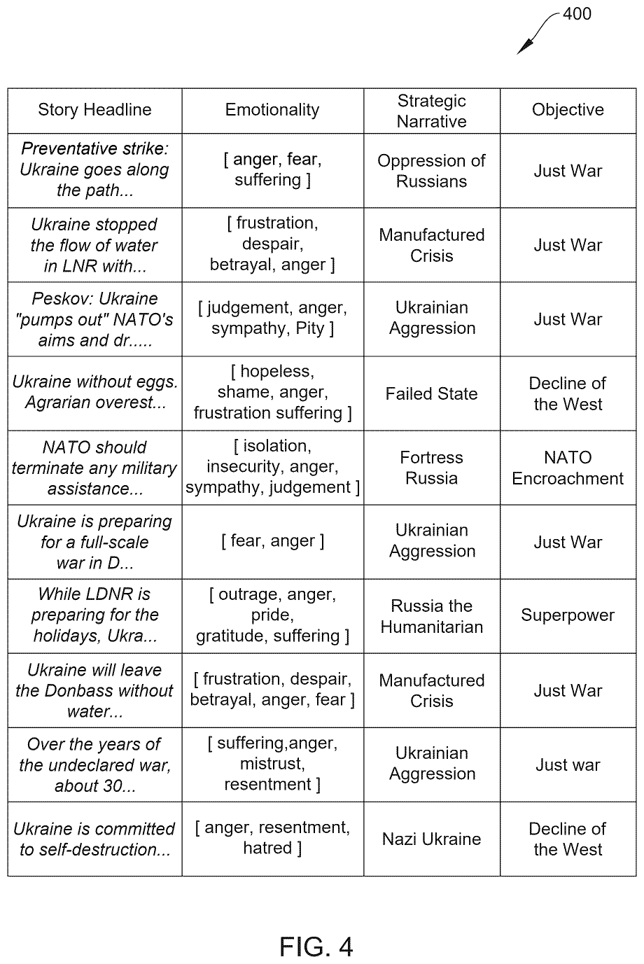

At operation 204, each content item of the plurality of content items are provided to a primary machine-learning model. The primary machine-learning model may be trained to determine whether one or more content items are associated with one or more predefined influence operations, such as of an influence entity (e.g., a country, business, organization, non-state actor, transnational criminal syndicate, or other entity running an influence or marketing campaign). In some examples, the influence operation may be a Russian, or other country's, information warfare master frame as discussed later herein with respect to FIGS. 4, 6, 7, and/or 9, as examples. In some examples, the one or more predefined influence operations each correspond to a respective influence entity (e.g., Russia, North Korea, China, Company X, Company Y, Company Z, etc.). Additionally, or alternatively, at least one of the one or more predefined influence operations may correspond to a respective individual, company, organization, or other entity recognized by those of ordinary skill in the art.

In some examples, training the primary machine-learning model may include aggregating a plurality of training content items (e.g., articles, blog posts, news stories, short-form messages, video files (e.g., short-form videos), image files and/or text descriptions thereof, audio files and/or text transcriptions thereof (e.g., radio)). The training may further include labelling each training content item of the plurality of training content items to be associated with a respective one or more predefined influence operations (e.g., a business′, country's, and/or organization's influence or marketing campaign). In some examples, labelling includes adding descriptive tags, annotations, and/or codes to content items, such as to categorize, classify, or provide additional context for the content items. The labelling may be performed by a content analyzer, such as a person who is trained on how to label content items according to mechanisms provided herein. In some examples, the training includes labelling at least one training content item of the plurality of content items to be associated with a respective new influence operation. For example, if a content analyzer believes that a content item is not accurately associated within any predefined influence operation, then the content analyzer may create a new influence operation which may be associated with content items. In some examples, the new influence operation may then become a predefined influence operation, such as for subsequent labelling of content items (e.g., for a model currently being trained and/or for training of a future model). Additionally, and/or alternatively, in some examples, the new influence operation may then become a predefined influence operation for trained machine learning models to associate content items therewith (e.g., based on training that included the new influence operation as an option when labelling content items). Accordingly, in some examples, the training includes labelling each training content item of the plurality of training content items to be associated with a respective one or more predefined or new influence operations.

The training may further include outputting the plurality of training content items with corresponding indications of the associated one or more predefined or new influence operations. For example, the outputting may include defining a data set, such as a data set on which the primary machine-learning model is trained. In some examples, the data set may be cleaned, processed, and/or calibrated, as discussed in further detail later herein. In some examples, the data set is an annotated dataset wherein each training content item is annotated with a respective indication of its associated one or more predefined or new influence operations.

In some examples, the primary machine-learning model does not use embeddings or deep learning. In such examples, the primary machine-learning model has explain-ability, such that every decision can be backed up with weighted feature predictions.

In some examples, prior to providing each content item of the plurality of content items to a primary machine-learning model, a language of at least one content item of the plurality of content items is identified. For example, the language may be Russian, English, Mandarin Chinese, or any other language that may be recognized by those of ordinary skill in the art. In some examples, the primary machine-learning model is selected from a plurality of machine learning models, based on the identified language of the at least one content item. For example, there may be a respective trained machine-learning model for each language that may be detected (e.g., a machine-learning model specific to Russian content items, a machine-learning model specific to English content items, a machine-learning model specific to Mandarin Chinese content items, etc.).

At operation 206, it is determined whether at least one content item is associated with the one or more predefined influence operations. For example, the determination may be performed by the primary machine-learning model, such as based on the training of the primary machine-learning model on an annotated dataset of content items.

If it is determined that at least one content item is not associated with one or more predefined influence operations, flow branches “NO” to operation 208, where a default action is performed. For example, the content items may have an associated pre-configured action. In other examples, method 200 may include determining whether the content items have an associated default action, such that, in some instances, no action may be performed as a result of the received content items. Method 200 may terminate at operation 208. Alternatively, method 200 may return to operation 202 to provide an iterative loop of receiving a plurality of content items from a at least one internet source, and determining if at least one content item is associated with one or more predefined influence operations.

If, however, it is determined that at least one content item is associated with one or more predefined influence operations, flow instead branches “YES” to operation 210, where, from the primary machine-learning model, an indication is received that at least one content item of the plurality of content items is associated with one or more predefined influence operations. In some examples, operation 210 includes identifying which content item of the at least one content items is associated with which predefined influence operation(s) of the one or more predefined influence operations. In some examples, the at least one content item that is associated with one or more predefined influence operations is a plurality of content items which are each associated with respective one or more predefined influence operations.

At operation 212, the at least one content item is provided to at least one secondary machine-learning model. The at least one content item may be provided to the at least one secondary machine-learning model to determine whether one or more content items of the at least one content item are associated with one or more predefined diverse narratives. In some examples, the at least one secondary machine-learning model is a plurality of secondary machine-learning models. The one or more predefined diverse narratives may be diverse narratives for the one or more predefined influence operations, such as the diverse narratives discussed later herein with respect to FIGS. 4, 5, 6, and 9, related to Russian influence operations, as examples.

In some examples, prior to providing the at least one content item to at least one secondary machine-learning model, the at least one content item is converted to text. Accordingly, in such examples, the text may be provided to the at least one secondary machine-learning model as input.

In some examples, training the secondary machine-learning model may include aggregating a plurality of training content items (e.g., articles, blog posts, news stories, short-form messages, video files (e.g., short-form videos), image files and/or text descriptions thereof, audio files and/or text transcriptions thereof (e.g., radio), etc.). The plurality of training content items may be the same or different as training content items used to train the primary machine-learning model. The training may further include labelling each training content item of the plurality of training content items to be associated with a respective one or more predefined diverse narratives (e.g., narratives that a business, country, and/or organization seeks to convey to an audience, such as during an influence or marketing campaign). The labelling may be performed by a content analyzer, such as a person who is trained on how to label content items according to mechanisms provided herein. In some examples, the training includes labelling at least one training content item of the plurality of content items to be associated with a respective new diverse narrative. For example, if a content analyzer believes that a content item is not accurately associated within any predefined diverse narratives, then the content analyzer may create a new diverse narrative label which may be associated with content items. Accordingly, in some examples, the training includes labelling each training content item of the plurality of training content items to be associated with a respective one or more predefined or new diverse narratives.

The training may further include outputting the plurality of training content items with corresponding indications of the associated one or more predefined or new diverse narratives. For example, the outputting may include defining a data set, such as a data set on which the secondary machine-learning model is trained. In some examples, the data set may be cleaned, processed, and/or calibrated, as discussed in further detail later herein. In some examples, the data set is an annotated dataset wherein each training content item is annotated with a respective indication of its associated one or more predefined or new diverse narratives.

In some examples, the secondary machine-learning models do not use embeddings or deep learning. In such examples, the secondary machine-learning models have explain-ability, such that every decision can be backed up with weighted feature predictions.

In some examples, such as when the at least one secondary machine-learning model is a plurality of secondary machine-learning models, the plurality of secondary machine-learning models each correspond to a respective diverse narrative. For example, a particular machine-learning model of the plurality of secondary machine-learning models may provide a binary output (i.e., 0 for no, 1 for yes, or vice-versa) indicative of whether an input to the particular machine-learning model is associated with a first diverse narrative. Comparatively, a different machine learning model of the plurality of secondary machine-learning models may provide a binary output (i.e., 0 for no, 1 for yes, or vice-versa) indicative of whether an input to the particular machine-learning model is associated with a second diverse narrative.

As another example, a particular machine-learning model of the plurality of secondary machine-learning models may provide as output a continuous variable between 0 and 1, such that if the variable is in a first range (e.g., between 0 and 0.49 (inclusive)) then the variable is indicative of an input to the particular machine-learning model not being associated with a first diverse narrative, and if the variable is in a second range (e.g., between 0.5 and 1 (inclusive)) then the variable is indicative of the input to the particular machine-learning model being associated with the first diverse narrative. Comparatively, a different machine learning model of the plurality of secondary machine-learning models may provide a continuous output (e.g., between 0 and 0.49 for no, between 0.5 and 1 for yes, or vice-versa) indicative of whether an input to the particular machine-learning model is associated with a second diverse narrative.

In some examples, each predefined diverse narrative of the one or more predefined diverse narratives correspond to one or more selected from the group of: a diagnostic frame and a prognostic frame. For example, a predefined diverse narrative may correspond to a diagnostic frame and/or a prognostic frame. In some examples, a diagnostic frame relates to a problem that is being identified and who/what is being blamed. In some examples, a prognostic frame relates to how solutions are being promoted and who/what is being praised/credited for those solutions. In some examples, framing, as discussed herein relates to how subject/objects are being weighted and/or evaluated in language, such as based on linguistics of statements.

In some examples, framing may be identified using labels, as discussed herein, and as opposed to other types of natural language processing, such as sentiment analysis, which could inaccurately interpret language to be associated/unassociated with a diverse narrative, based on positively/negatively conveyed sentiments. In some examples, language may have positive sentiment, but still be associated with an influence operation and/or diverse narrative. On the other hand, in some examples, language may have negative sentiment, but still be associated with an influence operation and/or diverse narrative. Accordingly, techniques provided herein which rely on analyzing language based on framing can be more accurate than, and therefore advantageous over, conventional techniques.

At operation 214, it is determined whether any of the at least one content item are associated with one or more predefined diverse narratives. For example, the determination may be performed by the secondary machine-learning model, such as based on the training of the secondary machine-learning model on an annotated dataset of content items.

If it is determined that none of the at least one content item are associated with one or more predefined diverse narratives, flow branches “NO” to operation 208, described above. If, however, it is determined that any of (e.g., one or more content items of) the at least one content item are associated with one or more diverse narratives, flow instead branches “YES” to operation 216, where, from the secondary machine-learning model, an indication of one or more predefined diverse narratives that are associated with one or more content items of the at least one content item are received. In some examples, operation 216 includes identifying which content item of the one or more content items of the at least one content item is associated with which predefined diverse narrative(s) of the one or more predefined diverse narratives. In some examples, the one or more content items of the at least one content item that are associated with one or more predefined diverse narratives are a plurality of content items which are each associated with respective one or more diverse narratives.

At operation 218, an output is provided based on the indication of one or more predefined diverse narratives. For example, the output may include a report, a plot, a table, organized data, and/or raw data. In some examples, the output may include rankings of which diverse narratives are most prevalent and/or most concerning (e.g., based on a specific context). In some examples, the output may be provided to a downstream process for further processing. In some examples, the output may be displayed, such as on a computing device (e.g., computing device 102). In some examples, actions may be performed by a system and/or person in response to receiving the output, such as to combat the detected one or more influence operations and/or diverse narratives. Additional and/or alternative types of outputs and/or uses thereof may be recognized by those of ordinary skill in the art, at least in light of teachings provided herein.

Method 200 may terminate at operation 218. Alternatively, method 200 may return to operation 202 (or any other operation from method 200) to provide an iterative loop, such as of receiving a plurality of content items from at least one internet source, determining if/which influence operations are associated with one or more of the content items, and if so, determining if/which diverse narratives are associated with one or more of the content items.

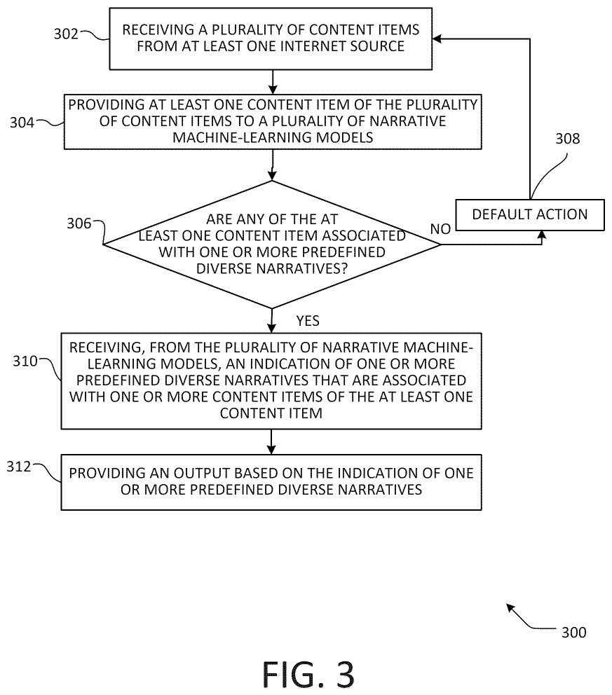

FIG. 3 illustrates an example method 300 for identifying diverse narratives, according to some aspects described herein. In examples, aspects of method 300 are performed by a device, such as computing device 102 and/or server 104, discussed above with respect to FIG. 1.

Method 300 begins at operation 302, wherein a plurality of content items are received. In some examples, the plurality of content items are received from at least one internet source. The at least one internet source may be the same or similar as the content data sources 106 discussed earlier herein with respect to FIG. 1. In some examples, the at least one internet source can be a plurality of internet sources. In some examples, the plurality of content items may correspond to the content data 110 discussed earlier herein with respect to FIG. 1. For example, the plurality of content items may include one or more selected from the group of: articles, blog posts, news stories, short-form messages, video files (e.g., short-form videos), image files and/or text descriptions thereof, audio files and/or text transcriptions thereof (e.g., radio). Examples of long-form content items may include articles, blog posts, and/or news stories. In some examples, at least one content item of the plurality of content items may be in English. In some examples, at least one content item of the plurality of content items may be in a language other than English, such as Russian, Mandarin Chinese, Spanish, etc. Additional and/or alternative languages will be recognized by those of ordinary skill in the art.

At operation 304, at least one content item is provided to a plurality of narrative machine-learning models. The at least one content item may be provided to the plurality of narrative machine-learning models to determine whether one or more content items of the at least one content item are associated with one or more predefined diverse narratives. The one or more predefined diverse narratives may be diverse narratives for one or more predefined influence operations, such as the diverse narratives discussed later herein with respect to FIGS. 4, 5, 6, and 9, related to Russian influence operations, as examples.

In some examples, prior to providing the at least one content item to the plurality of narrative machine-learning models, the at least one content item is converted to text. Accordingly, in such examples, the text may be provided to the plurality of narrative machine-learning models as input.

In some examples, training the narrative machine-learning model may include aggregating a plurality of training content items (e.g., articles, blog posts, news stories, short-form messages, video files (e.g., short-form videos), image files and/or text descriptions thereof, audio files and/or text transcriptions thereof (e.g., radio)). The training may further include labelling each training content item of the plurality of training content items to be associated with a respective one or more predefined diverse narratives (e.g., narratives that a business, country, and/or organization seek to convey to an audience, such as during an influence or marketing campaign). The labelling may be performed by a content analyzer, such as a person who is trained on how to label content items according to mechanisms provided herein. In some examples, the training of the narrative machine-learning models includes labelling at least one training content item of the plurality of content items to be associated with a respective new diverse narrative. For example, if a content analyzer believes that a content item is not accurately associated within any predefined diverse narratives, then the content analyzer may create a new diverse narrative label which may be associated with content items. Accordingly, in some examples, the training includes labelling each training content item of the plurality of training content items to be associated with a respective one or more predefined or new diverse narratives.

The training may further include outputting the plurality of training content items with corresponding indications of the associated one or more predefined or new diverse narratives. For example, the outputting may include defining a data set, such as a data set on which the narrative machine-learning models are trained. In some examples, the data set may be cleaned, processed, and/or calibrated, as discussed in further detail later herein. In some examples, the data set is an annotated dataset wherein each training content item is annotated with a respective indication of its associated one or more predefined or new diverse narratives.

In some examples, the narrative machine-learning models do not use embeddings or deep learning. In such examples, the narrative machine-learning models have explain-ability, such that every decision can be backed up with weighted feature predictions.

In some examples, the plurality of narrative machine-learning models each correspond to a respective diverse narrative. For example, a first narrative machine-learning models may provide a binary output (i.e., 0 for no, 1 for yes, or vice-versa) indicative of whether an input to the first narrative machine-learning model is associated with a first diverse narrative. Comparatively, a second narrative machine-learning model may provide a binary output (i.e., 0 for no, 1 for yes, or vice-versa) indicative of whether an input to the second narrative machine-learning model is associated with a second diverse narrative.

As another example, a particular machine-learning model of the plurality of secondary machine-learning models may provide as output a continuous variable between 0 and 1, such that if the variable is in a first range (e.g., between 0 and 0.49 (inclusive)) then the variable is indicative of an input to the particular machine-learning model not being associated with a first diverse narrative, and if the variable is in a second range (e.g., between 0.5 and 1 (inclusive)) then the variable is indicative of the input to the particular machine-learning model being associated with the first diverse narrative. Comparatively, a different machine learning model of the plurality of secondary machine-learning models may provide a continuous output (e.g., between 0 and 0.49 for no, between 0.5 and 1 for yes, or vice-versa) indicative of whether an input to the particular machine-learning model is associated with a second diverse narrative.

In some examples, each predefined diverse narrative of the one or more predefined diverse narratives correspond to one or more selected from the group of: a diagnostic frame and a prognostic frame. For example, a predefined diverse narrative may correspond to a diagnostic frame and/or a prognostic frame. In some examples, a diagnostic frame relates to a problem that is being identified and who/what is being blamed. In some examples, a prognostic frame relates to how solutions are being promoted and who/what is being praised/credited for those solutions. In some examples, framing, as discussed herein relates to how subject/objects are being weighted and/or evaluated in language, such as based on linguistics of statements.

In some examples, framing may be identified using labels, as discussed herein, and as opposed to other types of natural language processing, such as sentiment analysis, which could inaccurately interpret language to be associated/unassociated with a diverse narrative, based on positively/negatively conveyed sentiments. In some examples, language may have positive sentiment, but still be associated with an influence operation and/or diverse narrative. On the other hand, in some examples, language may have negative sentiment, but still be associated with an influence operation and/or diverse narrative. Accordingly, techniques provided herein which rely on analyzing language based on framing can be more accurate than, and therefore advantageous over, conventional techniques.

At operation 306, it is determined whether any of the at least one content item are associated with one or more predefined diverse narratives. For example, the determination may be performed by the narrative machine-learning model, such as based on the training of the narrative machine-learning model on an annotated dataset of content items.

If it is determined that none of the at least one content item are associated with one or more predefined diverse narratives, flow branches “NO” to operation 308, where a default action is performed. For example, the content items may have an associated pre-configured action. In other examples, method 300 may include determining whether the content items have an associated default action, such that, in some instances, no action may be performed as a result of the received content items. Method 300 may terminate at operation 308. Alternatively, method 300 may return to operation 302 to provide an iterative loop of receiving a plurality of content items from at least one internet source, and determining if at least one content item is associated with one or more predefined diverse narratives.

If, however, it is determined that any of (e.g., one or more content items of) the at least one content item are associated with one or more diverse narratives, flow instead branches “YES” to operation 310, where, from the plurality of narrative machine-learning models, an indication of one or more predefined diverse narratives that are associated with one or more content items of the at least one content item are received. In some examples, operation 310 includes identifying which content item of the one or more content items of the at least one content item are associated with which predefined diverse narrative(s) of the one or more predefined diverse narratives. In some examples, the one or more content items of the at least one content item that are associated with one or more predefined diverse narratives is a plurality of content items which are each associated with respective one or more diverse narratives.

At operation 312, an output is provided based on the indication of one or more predefined diverse narratives. For example, the output may include a report, a plot, a table, organized data, and/or raw data. In some examples, the output may include rankings of which diverse narratives are most prevalent and/or most concerning (e.g., based on a specific context). In some examples, the output may be provided to a downstream process for further processing. In some examples, the output may be displayed, such as on a computing device (e.g., computing device 102). In some examples, actions may be performed by a system and/or person in response to receiving the output, such as to combat the detected one or more influence operations and/or diverse narratives. Additional and/or alternative types of outputs and/or uses thereof may be recognized by those of ordinary skill in the art, at least in light of teachings provided herein.

Method 300 may terminate at operation 312. Alternatively, method 300 may return to operation 302 (or any other operation from method 300) to provide an iterative loop, such as of receiving a plurality of content items from at least one internet source and determining if/which diverse narratives are associated with one or more of the content items.

Drawing from a field of frame analysis, some examples provided herein include a content analysis framework to identify discrete diagnostic and prognostic communication frames propaganda, such as in Russian, or any country's, propaganda (e.g., pertaining to the war in Ukraine), which in turn serve as training data for developing new machine learning models. Results provided herein indicate that supervised machine learning models rooted in frame analysis can reliably identify stories belonging to influence operations (e.g., Russian information offensives in Ukraine) with an accuracy ranging from 85-91%. The reliability of some models provided herein suggests supervised machine learning tools may be well positioned to improve international defender community's ability to understand, anticipate, and disrupt influence operations in contested information environments.

Mechanisms provided herein can identify how influence operations function in any language and/or across cultures. For instance, some examples provided herein discuss how mechanisms provided herein may analyze Russian language influence operations. However, those of ordinary skill in the art will recognize how mechanisms provided herein may be used on any language, dialect, influence operations, etc.

Advantages of mechanisms provide herein include producing output that identifies intended target audiences. In some examples, additional and/or alternative benefits include the ability to provide measurable, refined, cleaned, and enriched data for decision-makers that yields timely and highly accurate assessments to produce a decision-advantage to an end user. For example, mechanisms provided herein produce data that identifies targeting data for adversarial information conduits, such as via node and cluster identification. Some examples provided herein provide indicators, such that receivers of the indicators can directly and/or indirectly generate effective counter messaging and cyberspace actions against targeted networks.

Some examples provided herein relate to protecting democracies. In such examples, it is noted that a weaponization of information against democracies is an attack on a liberal epistemic order (e.g., a society's capacity to critically assess reality and reliably act in the public interest). In some examples, an information defense, therefore, requires a collaborative and resilient analytical framework to effectively respond to information threats. In some examples, the collection of appropriate data and the separation of signal from noise is exceedingly difficult.

A plurality of conventional initiatives for countering information warfare (IW) remain concerned with fact-checking and journalism, while failing to address the needs for analytical tools, societal resilience, and countermeasures. From a social cybersecurity perspective, information may achieve influence by affecting human cognition and social networks-targets which may not be neatly delineated along the rational, rules-based logic of empirical observation and fact-checking.

With these deficiencies of conventional techniques in mind, mechanisms provided herein may be useful to cure these deficiencies, as well as having other benefits and/or advantages that may be recognized by those of ordinary skill in the art, at least in light of the present disclosure. For example, some mechanisms provided herein provide an analytical toolkit to inform countermeasures for informational warfare.

Using Russia's operations against Ukraine as one non-limiting example, mechanisms provided herein may be used to design, test, and assess a supervised machine learning approach to content analysis for the detection and measurement of adversarial influence operations. In some examples, as opposed to truth-centric approaches to disinformation analysis, the analytical framework described herein draws from frame analysis traditions to identify narrative tactics in Russia's strategic information operations. In doing so, mechanisms provided herein may beneficially advance conventional techniques from within the information warfare research community.

Mechanisms provided herein may provide reliability and/or validity in treatment of political communication, and provides tools that can capture, analyze, understand, anticipate, and disrupt influence operations.

According to some aspects, Russian disinformation literature includes a robust characterization of the Kremlin's strategic approach to information warfare (IW)-a doctrine that assumes a constant state of conflict in the information space and which seeks to reflexively control the decision making of target audiences not through persuasion but by undermining the possibility for objectivity and critical thinking. While the disinformation literature includes concepts such as diverse narrative, strategic/diverse framing provides several insights that can help to further distill propaganda into data expressing ideas that produce an interpretive meaning for an audience. In some examples, frames operate in four ways: to define problems, diagnose causes, make moral judgments, and suggest remedies. In some examples, aspects provided herein have three core framing tasks. First, a diagnostic frame may be selected by a propagandist, influencer, and/or marketer to identify problems that need to be eliminated and those who are responsible. Second, in prognostic framing, solutions may be presented to counter injustices, provide strategies, construct tactics and foster a sense of justice in resolving the problems. Third, motivational framing may offer a concrete rationale for collective action required for a target audience to overcome fear and become actively engaged.

Despite its concentration on the capacity for information to strategically mobilize target audiences, in some examples, frame analysis does not adequately address information warfare at an international level. In some examples, in a globally diffused information environment, Russia cannot direct messages at selected individuals and expect them to necessarily respond in a desired manner. In some examples, instead, diverse narratives are directed to individuals who are in a person's social network to leverage relationships for disseminating information. The relationship between diverse disinformation and social mobilization remains largely unexplored by data-driven scholarship, which has largely focused on tactics, operational goals and exposure effects. While several recent studies have explored the relationship between frames and narratives in information warfare, the field has generally neglected to develop frameworks that deconstruct Russia's strategic doctrine of information warfare into detectable quantitative signatures such that what is being said can be tied to why it is said strategically and how it might socially mobilize malign effects. By leveraging insights from both disinformation and frame analysis literatures, some mechanisms provided herein attempt to construct an analytical framework to identify actionable indicators of Kremlin-sponsored disinformation with the potential to cause harm in the Ukrainian conflict theater.

Some examples provided herein use contextualized and enriched data to test how diagnostic and prognostic frames are important to propaganda, influence, and/or marketing campaigns, such as by Russia, another country, organization, company, or entity. While some examples described herein are specific to Russian propaganda campaigns, it should be recognized by those of ordinary skill in the art that mechanisms described herein may be similarly applied to influence operations orchestrated by other countries or entities (e.g., organizations, people, etc.).

In some examples, diagnostic and prognostic frames are central to Russian propaganda communication frames and can be identified in individual Russian-language stories discussing the war in Ukraine. In some examples provided herein, “frames” refer to how a subject/object is being weighted and/or linguistically evaluated based on the context in which the subject/object is being used.

In some examples, propaganda stories include existing grievances of their target audience. In some examples, locally resonating topics and themes of grievance enhance an appeal of mobilizing stories. In some examples, Russian stories about the Ukraine crisis show frames that blame and vilify the Ukrainian government and its allies, while praising and promoting the actions of the Russian government.

In some examples, high-performing supervised machine learning models can be trained on labelled frame analysis data. In some examples, recurring communication frames can serve as reliable training data for supervised machine learning of influence operations, such as Russian propaganda about the war in Ukraine.

In some examples, frames used in Russian propaganda can serve as the foundation for reliably detecting Russian propaganda and its tactical deployment in its Ukrainian information operations. In some examples, propaganda stories advancing a discrete frame, such as those framing the Ukrainian government as an aggressor and provocateur, will share certain recurring linguistic elements in assigning blame and praise, identifying problems, and promoting solutions. In some examples, using supervised machine learning, aspects of the present disclosure test whether and to what degree detection models based on diagnostic and prognostic framing can more reliably identify and interpret Russian information warfare as it is waged.

Some examples provided herein detail identification techniques of social mobilization frames in content items from internet sources, such as stories identified as pro-Russian propaganda about the war in Ukraine. In some examples, mechanisms provided herein come up with a list of plausible diverse narratives to form a basis of large-scale content analysis. Accordingly, a benefit of mechanisms provided herein may be scalability for analyzing relatively large quantities of content items from a plurality of different internet sources. In some examples, influence operations rely on targeting audiences from a plurality of different internet sources. Therefore, mechanisms herein that receive content items from a plurality of different internet sources may be advantageous for accurately identifying influence operations.

In some examples, emerging stories include new Russian content identified as disinformation (communication of knowingly false information) and propaganda (messaging aligned with Russian government positions with intent to influence). In some examples, to identify stories with these attributes, unsupervised machine learning clustering on top of headlines translated into a unifying language (English) may be used to group similar stories and to identify specific frames that are frequently used to characterize the Russian-Ukrainian conflict. In doing so, some examples identified and analyzed emotionally charged language framing who is to blame for the conflict unfolding in Ukraine.

In some examples, a corpus content consisted of data from Russian and Ukrainian domains that either publish or share stories about the crisis taking place in Ukraine. In some examples, analysis of headlines and full text data from the domains follows in order to understand how similar narratives propagate across different domains and to surface how the Kremlin is exploiting communication frames to depict the nature of the Ukraine crisis. In some examples, raw data used for analysis provided herein was provided by multiple sources, such as from which over 36,000 Russian language headlines and full-text content from more than 860 Russian-language websites were collected.

In some examples, at this phase, unsupervised machine learning quickly isolates and identifies Russian propaganda stories by isolating clusters of headlines using keywords of interest. In some examples, looking through clustered data, mechanisms provided herein are able to identify stories from Russian language websites meeting pre-defined definitions for disinformation and propaganda. In some examples, processes provided herein include identifying emotional frames in stories, framing patterns in diverse narratives, and finally determining diverse narratives in Russia's strategic foreign policy objectives.

In some examples, data is collected from a plurality of sources (e.g., businesses, organizations, etc. that store and/or collect data related to aspects of the present disclosure). In some examples, the domains from which the data is collected are identified using network science, such as to continuously discover new domains affiliated with previously identified domains of interest to purposes of mechanisms provided herein. In some examples, a source's databases have the potential to grow exponentially, but in some examples databases are structured to identify content that is considered high signal.

Some examples of data fields used by mechanisms provided herein include a plurality of different fields. For example, the fields may include one or more from the group of: “Domain,” “url,” “url domain,” “date added,” “title,” “title translated,” “summary,” “summary translated,” “text,” “text translated,” “authors,” “language,” and “registered in.” The “Domain” field may include a domain name (e.g., with extension, such as .com, .org, .gov, etc.). The “url” field may include a full uniform resource locator (URL) for an article.

The “url domain” field may include the domain of an article, which can be different than the “domain” field. In some examples, the “date added” field includes the date an article was collected and stored in a database from which it was collected/retrieved. In some examples, the “title” field includes the title of an article. In some examples, the “title translated” field includes the title of an article translated into English. In some examples, the “text” field includes the full text of a scraped article. In some examples, the “text translated” field includes the full text of an article translated into English. In some examples, the “authors” field includes the authors of an article, if available and/or obvious on a webpage. In some examples, the “language” field includes in what language an article was published. In some examples, the “registered in” field includes in what country a domain was registered, if available. Additional and/or alternative fields and/or descriptions for such fields and/or fields discussed herein may be recognized by those of ordinary skill in the art, at least in light of teachings provided herein. In some examples, data used during exploratory and/or during content analysis consists of 65,388 publicly accessible Russian-language articles. In some examples, one or more databases from which content items discussed herein are retrieved is at an article level. Therefore, in some examples, a URL references a direct link to a specified article in the databases. In some examples, languages analyzed for the building of classifiers are Russian and English, for simplicity. In some examples, a language of publication could be considered representative of a target audience of a message and the IP registration country could be considered a source country of the message.

Some aspects provided herein include creating an annotated dataset. In some examples, mechanisms provided herein consider diagnostic and prognostic framing a process occurring in each story which ascribes emotions and responsibility for problems and solutions [e.g., anger+Zelensky+lack of clean drinking water]. In some examples, when a group of stories framing similar problems (diagnostic) and resolutions (prognostic) are observed, aspects provided herein may consider such a group to advance a shared diverse narrative [e.g., Failed State]. Consequently, in some examples, mechanisms provided herein are able to identify four primary high-level diverse (e.g., strategic) objectives that Russian diverse narratives advanced in a sample set: NATO Encroachment, Just War, Decline of the West, and Superpower. FIG. 4 illustrates an example table 400 in which story headlines are analyzed. For example, an emotionality of each story headline is identified. In some examples, a diverse narrative for the story is identified (e.g., oppression of Russians, manufactured crisis, failed state, etc.). In some examples, an objective for the story is identified (e.g., “just war,” “decline of the west,” “NATO encroachment,” “superpower”).

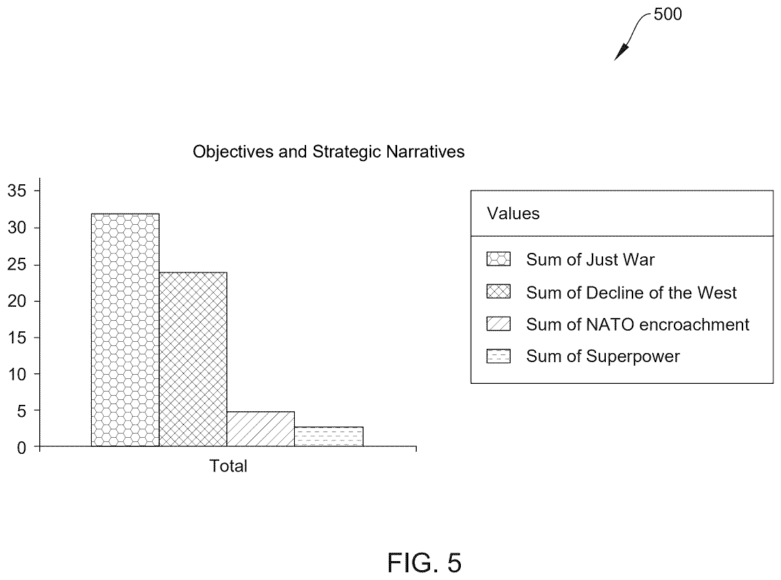

FIG. 5 illustrates an example plot 500 of objectives and diverse narratives. In some examples, analysis suggests that frames, such as social mobilization frames, are both prevalent and identifiable in Russian propaganda. In a small sample of content items, according to one example, narratives identifying who is to blame for hostilities (Just War) and those undermining the moral and physical capacity of Ukraine and its Western allies (Decline of the West) are prioritized in Russia's framing of the escalating crisis (as shown in FIG. 5). In other words, identifying frames according to some aspects provided herein allows for distinct and prominent enough categorizations for supervised machine learning to accurately predict/identify influence operations. For example the supervised machine-learning models may be trained based on datasets of content items that are pre-categorized into such frames, labelled to identify such frames, or otherwise indicated to be associated with such frames.

In some examples, refinement of frames was completed, such as propaganda frames in Russian influence operations against Ukraine, and the development of a formal coding instrument for systematic content analysis was determined. In some examples, additional/alternative diverse narratives may be posited than those explicitly illustrated herein (e.g., “superpower” and “information war”). In some examples, narratives identified in exploratory analysis may be refined for broader interpretability and to minimize confusion (e.g., “Western and Ukrainian aggression” combined into “Aggression & Provocation,” “Nazi Ukraine” expanded to “Extremists,” “Manufactured Crisis” may be renamed to “False Flag/Conspiracy,” and/or “American imperialism” may be removed as redundant). In some examples, Russia's overarching narrative objectives are streamlined to conform with pre-determined national foreign policy strategies (see FIG. 4). In some examples, “Decline of the West” may be otherwise labelled, such as with “Undermine the influence of the West.” In some examples, “Just War” and “NATO Encroachment” may be combined into “Reestablish a sphere of influence in Eastern Europe.” In some examples, “Superpower” may be renamed, such as with “Global power projection.” In some examples, Russian diverse narratives may be conceptualized as collective action frames constructing permissive environments in which operations can reflexively control audiences and decision-makers, such as by dismissing critical and competing versions of Russia's military operation, distorting facts behind an operation and its conduct, distracting from unfavorable aspects of a conflict, and/or dismaying audiences from sharing dissenting or alternative viewpoints.

In some examples, labelling or coding of narratives for influence operations may be grounded in content analysis: a research methodology which may be broadly used to classify written content in content items (e.g., articles, blog posts, news stories, short-form messages, video files (e.g., short-form videos), image files and/or text descriptions thereof, audio files and/or text transcriptions thereof (e.g., radio)) selected for analysis. In some examples, a customized coding instrument assigns quantitative values to qualitative linguistic characteristics in each article (e.g., whether an article contains a Russian propaganda frame), allowing for quantitative analysis of text data. In some examples, mechanisms provided herein are configured to assess Russian propaganda framing. In some examples, mechanisms provided herein capture causal logic behind the Kremlin's version of reality, identifying the causes of problems challenging the Russian Federation and the effectiveness of their preferred solutions. In some examples, content analysis performed according to aspects provided herein classifies symbolic value of diagnostic and prognostic representations of events described in Russian propaganda, with diagnostic signs assigning a cause for a problematic effect (e.g., violent Russophobia), and prognostic signs proposing a novel solution and predicting its beneficial effects (e.g., the Special Military Operation will cause positive effects).

In some examples, recurring patterns in this process form identifiable frames and narratives possessing both tactical and strategic significance. In some examples, from a strategic perspective, the causal logic propagated by Russian information warfare seeks to ensure continued support for the war effort among key constituencies by consistently ascribing responsibility for both negative (e.g., blame) and positive (e.g., praise) developments in Ukraine in a manner that displaces and undermines competing narratives, such as those advanced by Ukraine and the West, in neutral and contested environments (e.g., battleground communities in the Donbass, or Russian diaspora abroad). In some examples, diagnostic and prognostic frames prime an environment ahead of kinetic maneuvers, shape perceptions of ongoing operations, and/or draw attention away from the deleterious effects of developments like civilian casualties and defeats on a battlefield.

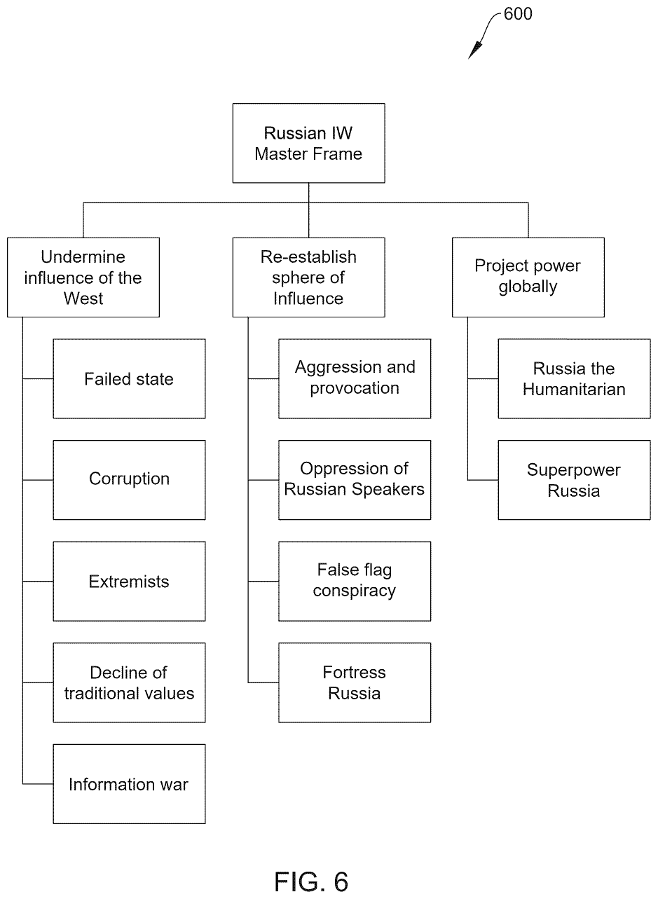

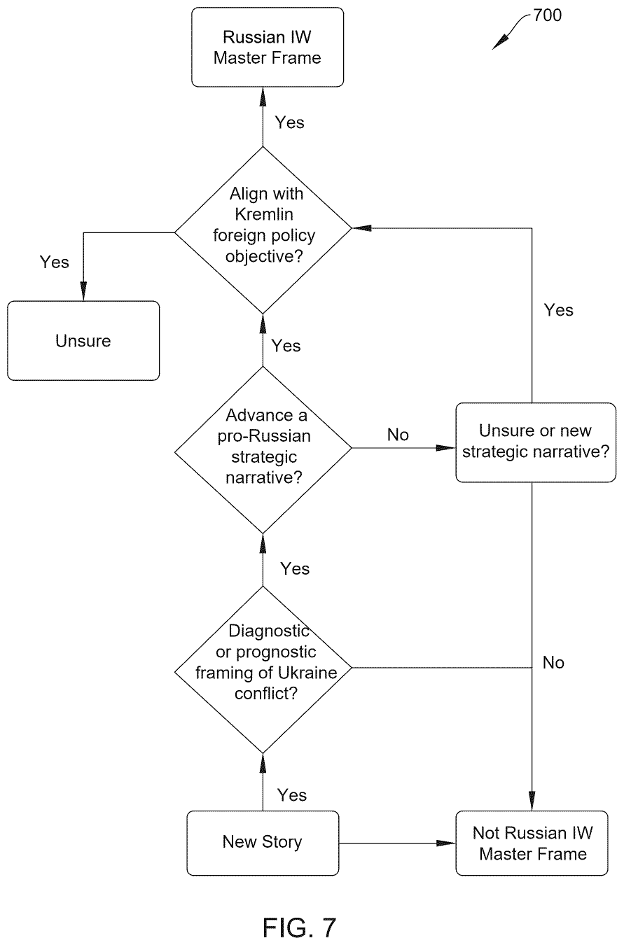

FIGS. 6 and 7 illustrate example flow 600 and 700, respectively, for analyzing Russian influence operations. The example flow 600 is a framework for content analysis of frames and diverse narratives, such as may be followed by content analyzers. The example flow 700 is a flowchart for applying a content analysis framework, such as may be followed by content analyzers. As an example, if a content item (e.g., a new story) is determined to be associated with one or more predefined influence operations (e.g., Russian information warfare or IW), using flow 700, then the content item may then be analyzed according the flow 600 to determine one or more predefined diverse narratives associated with the content item (e.g., Failed State, Corruption, Aggression and provocation, Superpower Russia, etc.). In some examples, the one or more predefined diverse narratives may be grouped by one or more categories (e.g., undermine influence of the west, re-establish sphere of influence, project power globally, etc.).

The example flows 600, 700 identify levels and overall scope of analysis and define functional roles and relationships of terminology, such as are used in coding/labelling techniques, analysis, and/or machine learning models. In some examples, frames are identified by content analysts (e.g., humans) depending on how events are represented, how problems are identified, and/or how resolutions are promoted. In some examples, when a locus of cause and effect is manifestly related across multiple stories, frames coalesce into a diverse narrative. In some examples, diverse narratives represent lines of effort supporting national-level diverse (e.g., strategic) objectives relevant to Russian information warfare. At a relatively high level of aggregation, the “Master Frame” represents a social mobilization frame encompassing a network of distinct narratives that share an operational domain, which, in the particular examples of FIGS. 6 and 7, is Russia's war with Ukraine. In some examples, a content item is determined to be part of a master frame, if the content item is part of an influence operation (e.g., propaganda campaign).

In some examples, a web application that supports the labeling of numerous data types for supervised learning, may be used to extract enriched data necessary for narrative analysis and ML modeling for propaganda detection. In some examples, the labeling interface is customizable, to streamline the usage for users thereof. In some examples, a labeling team goes through a training process and calibration period to consistently label stories. In some examples, the labeling interface is a user interface that is displayed on a computing device, such as computing device 102 of FIG. 1. In some examples, the labeling interface displays, for one or more content items, an Author (if available), Date Added, Domain, Title (translated to English), and/or Full Text of the content item (translated to English).

In some examples, annotators answer questions on a survey-like interface that includes a selection for “Does this story belong to a Russian master frame?” In some examples, the output of that selection yielded a 1 or “yes”, a 0 or “no” and a 2 or “unsure.” In some examples, the “unsure” selection indicates that a domain expert needs to re-review that story for quality control. Additionally and/or alternatively, a user of the labeling interface may label for one or more diverse narratives employed if a story was indicated to represent Russian propaganda (master frame). In some examples, a resulting labeled dataset forms an analysis or report of narrative tactics in operations over time. In some examples, the resulting labeled dataset forms training data for developing machine-learning models capable of automating propaganda detection, such as based on diagnostic and prognostic framing patterns establishing a Master Frame in Russia's information war in Ukraine.

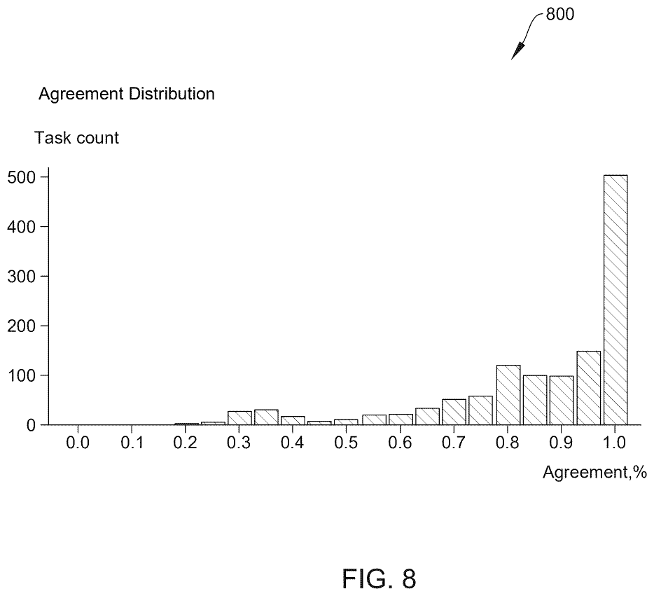

In some examples, during content analysis, intercoder reliability may be established in two ways. For example, all content analysts may undergo methodological (frame analysis) and subject-matter (Russia-Ukraine operational environment) training at a designated location. In some examples, prior to beginning content analysis, the group of content analysts may also undergo a calibration period to assess and establish a baseline of agreement and familiarity with labelling/coding mechanisms described herein. In some examples, agreement throughout content analysis may be monitored and evaluated on the web application, such as by requiring overlapping annotations by content analysts for a configurable amount of the data being annotated (e.g., 10% of the data). In some examples, at the end of a period of analysis, the vast majority of annotations possessed at least 80% agreement between two or more content analysts, as shown in the example plot 800 of agreement distribution in FIG. 8. In some examples, during data preparation for machine learning models, a protocol for resolving disagreements between annotated content items may be applied, as discussed in further detail later herein.

In some examples, an outcome of content analysis discussed above is the creation of a uniquely labelled dataset. The dataset may be used for training machine learning models and capture a basic narrative anatomy of influence operations, such as the Russian IW operations against Ukraine. In a particular example, a dataset may include 65,388 total content items (e.g., articles, blog posts, news stories, short-form messages, video files (e.g., short-form videos), image files and/or text descriptions thereof, audio files and/or text transcriptions thereof (e.g., radio)). A total of 12,278 annotations may be made corresponding to respective content items of the 65,388 total content items. A total of 10,269 of the total content items may be uniquely annotated content items. A total of 4,518 content items may be annotated as “Master Frame” (e.g., see FIG. 6) indicating that the content items are associated with a predefined influence operation. In some examples, a plurality of unique domains may be linked to the predefined influence operation, such as 323 unique domains for the 4,518 content items annotated as being associated with the predefined influence operation. The annotated articles may have a date range, such as a range of December 2021 to May 2022 for the 4,518 content items annotated as being associated with the predefined influence operation.

In some examples, diagnostic and prognostic framing are central to the creation of crises (diagnostic) necessitating kinetic measures (prognostic) in a physical environment. In some examples, whether influence operations can successfully manufacture perception and achieve its objectives depends on the extent to which layers of information manipulation and alternative realities rest upon a foundation of accurate intelligence and an objective understanding of an operational environment.

In some examples, narrative analysis using mechanisms provided herein reveals cognitive terrain Russia sought to establish immediately before and after their invasion of Ukraine (e.g., December 2021-April 2022). In some examples, a topography of this terrain concerns above all else the crisis of Ukrainian and Western aggression (“Aggression and Provocation”), and with it the exclusive placement of blame for hostilities upon Kyiv and its NATO partners. In some examples, flanking this primary diagnostic framing was the mutually supportive framing of adversaries as Nazis and violent extremists (“Extremist”), and the assertion that Russian territorial integrity and national security were under direct threat (“Fortress Russia”). In some examples, these diagnostic lines of effort were designed to necessitate prognostic narratives framing the Russian special military operation as an intervention that would protect and liberate civilians (“Russia the Humanitarian”) and destroy its adversaries with a high degree of efficacy and precision (“Superpower”). In some examples, the relationship between diagnostic and prognostic shaping of an information space juxtaposed a cabal of immoral, oppressive aggressors with a justified, humanitarian coalition of defenders.

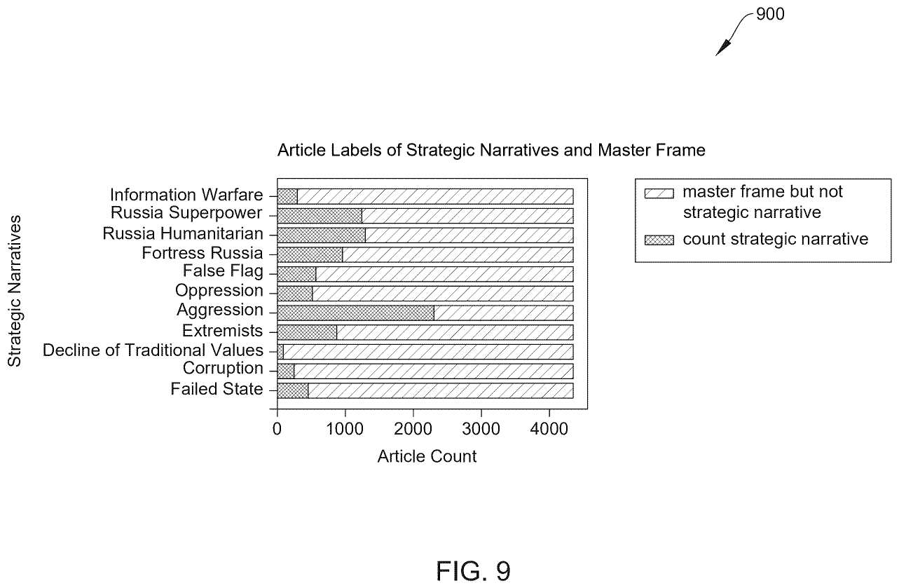

In some examples, the results of analyzing content items from a plurality of sources, according to mechanisms provided herein, provide diagnostic and prognostic frames, such as in Russian propaganda coalescing into a master frame of the Kremlin's war in Ukraine. FIG. 9 illustrates a plot 900 of article labels of diverse narratives and master frame. In some examples, seven of eleven pre-defined diverse narratives were identified in 500 or more unique stories. In some examples, the plot 900 illustrates the fundamental anatomy of Russian information warfare against Ukraine. In some examples, the plot 900 outlines priorities for problem identification and resolution promotion in the pro-Russian information environment.

In some examples, data produced from labeling/coding efforts are aggregated and cleaned, according to some mechanisms provided herein. In some examples, some of the data has overlapping annotations due to calibration efforts, such that deduplication may be performed, such that each story has a single annotation for a master frame (e.g., a predefined influence operation). In some examples, if there is a disagreement in a label on an outputted dataset, a mode function may be used to find a most common Russian master frame label for the given content item. In some examples, content items that are labeled with an unresolved “unsure” label are removed.

In some examples, word and/or character distributions are further analyzed, such as to reveal that untranslated content items (e.g., content items in Russian) that were labeled as 0 (e.g., not a Russian master frame) have on average 15 more words per story and 62 additional characters per story. In some examples, this differential can be attributed to difference in structure of the languages themselves. In some examples, along with the above aggregations, fields that are unnecessary for natural language processing (NLP) may be removed. For example, a dataset before cleaning may have 13,121 annotations, and after cleaning efforts, the dataset may contain 5,887 class 0 (e.g., not a master frame) labels and 4,383 class 1 (e.g., Russian master frame) labels for a total size of 11,270 valid annotations. In some examples, after deduplication efforts, a final dataset used for training a machine learning model may contain a total of 10,269 unique content items with annotations. In some examples, a distribution of the content items may be that 57% are labeled with 0, and 43% are labeled with 1.

Some mechanisms provided herein use text wrangling. Text wrangling for natural language processing is the process of transforming text from its raw format into a normalized format for modeling. There are several methods for performing this task that require experimentation and iteration through the ML modeling process. Stop word removal is a process of removing common words that do not add much information to a sentence. Words like “a,” “the,” “is,” and “are,” are all examples of stop words. In some cases where the scope of a text topic is narrow, it may also be appropriate to also remove words that are common to the domain. One word that is common to some example domains discussed herein is “Russia,” which may or may not add value to text being analyzed. Additionally and/or alternatively, it may sometimes be advantageous to remove short words of only 3 or 4 characters, such as to remove additional noise from text that may not add much value.

Removing special characters, punctuation and digits from the text is another common text wrangling method, which may be used by some mechanisms provided herein. In some examples, characters and digits also may not add value to the text analysis. In some examples, however, text that contains a lot of temporal data, such as dates, may need such characters or digits left in. In some examples, due to the methods in which content items may be scraped or otherwise collected from internet sources, newline characters (“\n”) may be removed from original Russian text and/or translated English text.

In some examples, to apply text wrangling techniques, text is broken into tokens. In some examples, tokens represent a list of words (e.g., all words) in the text, usually split by a space between text characters. In some examples, when vectorizing and analyzing the text, n-grams can also function as tokens when creating a vocabulary for training. In some examples, a vocabulary is one or more tokens that make up one or more training features. In some examples, during the process of tokenizing, text is transformed into all lowercase letters, as an additional normalization method, such as since a vocabulary of features may be case sensitive.

In some examples, stemming and/or lemmatization techniques may be used to reduce a size of the vocabulary of text by normalizing words into a common form. In some examples, stemming normalizes tokens by reducing the word to a stem of the word, which could have originally had suffixes and prefixes attached. As such, words like “leafs,” may become “leaf” and, “leaves” may become “leav.” In some examples, stemming results in versions of words that do not exist. In some examples, lemmatization, on the other hand, always results in a word that exists. In some examples, lemmatization normalizes text by converting each word to its root word. For example, using lemmatization for the previous “leafs,” and “leaves,” would cause the words be transformed to “leaf.” In some examples, lemmatization relies on part of speech (POS) tagging to get the correct inflected form of the lexeme. In some examples, after applying text wrangling methods discussed herein, the number of features for each class in datasets provided herein are successfully reduced.

In some examples, available fields of content items to train on include headlines, summaries, and full text, such as in one or more language (e.g., in English and/or Russian). In some examples, increased performed for detecting influence operations was found from using the full text, such as opposed to just the headlines and/or summaries of the full text.

In some examples, an optimal wrangling method for the Russian dataset includes removing new line characters (“/n”), lemmatizing, and lowering. In some examples, an optimal wrangling methods for the English dataset includes removing new line characters (“/n”), lemmatizing, lowering, and removing stop words, special characters, digits, and punctuation.

In some examples, machine learning models receive numerical features as input. In some examples, vectorization is the process of turning text into numerical values. Some examples for vectorizing text data include bag of words (BoW), Term Frequency-Inverse Document Frequency (TF-IDF), as well as embedding methods such as Word2Vec/Doc2Vec, and GloVe. In some examples, dimensionality reduction methods such as topic analysis are also performed before the vectorization step such as Latent Dirichlet Allocation (LDA), or Latent Semantic Analysis (LSA)/Single Value Decomposition (SVD).

In some examples, TF-IDF attempts to weight terms based on relevance. For example, this method may quantify the importance of a term to a document, while also accounting for how often it appears in the entire corpus. In some examples, a word like, “Russia,” which may be very common in the corpus, may appear several times in a story, but using the TF-IDF method, it will not be considered equally important as any other term, but inversely weighted by corpus frequency, leaving terms with more nuance to have appropriately heavier weights. In some examples, TF-IDF can be calculated using one or more of the following equations:

$$TF ( t , d ) = \frac{n umber of times t appears in d}{total number of terms in d} ,$$

$$IDF ( t ) = log \frac{N}{1 + df} ,$$

$$TF - IDF ( t , d ) = T F ( t , d ) * IDF ( t ) ,$$

where t is a term, d is a document, N is a number of documents in a corpus, and df is a number of documents that include the term. TF-IDF results in values between 0 and 1.

In some examples, LSA is a popular, unsupervised topic modeling technique that relies on word co-occurrence as well as SVD. In some examples, inputting a TF-IDF matrix, LSA creates less-sparse vectors by reducing dimensionality, such as by first breaking the matrix down to fewer dimensions by assuming a specific number of user-defined topics, then analyzing to understand which words explain the probabilities of these documents included in the topics. In some examples, this process greatly reduces the dimensions of the TF-IDF vectors. In some examples, LSA also accounts for how much each topic explains data. In some examples, since selecting the number of topics to fit the data to is user defined, this is an experimental step. In some examples, there is one topic that ends up being a “catch-all” for documents that do not fit into any other topic.

In some examples, when using the TF-IDF vectorization method, unigrams may be used only, bigrams may be used only, unigrams and bigrams may be used together, and/or unigrams, bigrams and trigrams may be used together. In some examples, unigrams and bigrams may be used as an n-gram range for TF-IDF vectorization for models, such as to create a static vocabulary for comparing models during the next experimental phase. In some examples, there may be more noise in the Russian text due to fewer wrangling methods applied in the final stages before modeling.

In some examples, models for binary classification include support vector classifier (SVC), logistic regression, multinomial naïve bayes, linear discriminant analysis (LDA), k-nearest neighbor (KNN), and/or a baseline bi-directional long short-term memory (LSTM) recurrent neural network (RNN). Additional and/or alternative models that may be used for binary classification described herein may be recognized by those of ordinary skill in the art. In some examples, separate models are created for respective languages, such as a first model for Russian text, a second model for English text (e.g., normalized English text), etc.

In some examples, the support vector machine (SVM) algorithm generates hyperplanes iteratively to distinctly separate classes efficiently. In some examples, hyperplanes are decision boundaries that exist in the same dimensional space as vectors (based on number of features) and support vectors are the datapoints closest to the hyperplane that help decide where the threshold lies. In some examples, the objective in an SVM is to maximize a margin so the classes can be most clearly separated. In some examples provided herein, an SVC creates a linear hyperplane and an SVM separates the data using a non-linear approach.

In some examples, logistic regression is a classification method where the objective is to calculate the probability that a datapoint is class 0 or class 1 since the output is always between (0, 1). In some examples, the logistic regression algorithm accomplishes this by analyzing relationships between features using a Sigmoid function.

In some examples, multinomial naïve bayes attempts to assign a class probability to each observation in the dataset. In some examples, Bayes Theorem assumes all features of each observation are independent and evaluates their class while ignoring sematic context (like co-occurrence). In some examples, the probability that each word is in a sentence is calculated, then Bayes Theorem is applied to determine the probability that the sentence, given the word probabilities, is in a specific class. In some examples, mechanisms then multiply the probability that the sentence is in a specific class by the probability that any sentence is in a specific class. In some examples, these probabilities are learned by how many times each word appears in the training set as class 0 or class 1 (e.g., in a binary case).

In some examples, LDA is a tool used for dimensionality reduction. In some examples, however, this algorithm may be used as a binary classifier by setting the hyperparameter for number of components equal to 1. In some examples, LDA is a linear classification technique. In some examples, LDA assumes that data has a normal distribution (Gaussian), and also uses Bayes Theorem to estimate the class probabilities. In some examples, the objective for LDA is to maximize the distance between the means of the two classes and minimize the variation in each class.

In some examples, KNN works off an assumption that similar data points can be found near each other in vector space. In some examples, classes are derived by a majority vote of a defined number (k) of neighbors surrounding the point in question. In some examples, this means that a label most frequently associated with a given data point is assigned.

In some examples, RNN represents a many-to-one network where one feature (word in a sentence/n-gram token) is input and order of features is taken into account to produce a single classification (sequential). In some examples, the input to an RNN is a sentence in plain text. In some examples, no previous vectorization needs to be computed before an RNN is trained (although it is an option). In some examples, a text vectorization layer uses an encoder to map text features to integers, and then the embedding layer turns those vectors created by the encoder into dense vectors of a fixed length. In some examples, from there, any number of bidirectional LSTM layers could be added. In some examples, the bidirectional layers are unique in an LSTM because they remember not only the data from the layer immediately previous but also from all the layers before, such as made possible via a process called parameter sharing that allows the inputs to be of varying lengths. In some examples, the RNN can pass information from future layers back to previous layers in a process called back-propagation. In some examples, LSTMs are capable of learning long-term dependencies between the features, such as: words of text. In some examples, a final layer of an RNN is a dense layer, meaning it is fully connected with the layer that immediately precedes it. In some examples, the dense layer requires an activation function that depends on the type of prediction the network is attempting to make. In some examples, a sigmoid activation function is used in the output layer for a binary classification problem.

In some examples, a final model type used for mechanisms provided herein is a calibrated classifier cross validation model. In some examples, calibrated classifier cross validation model allows for probability prediction for models that do not natively do so (e.g., the SVC), providing the SMEs the ability to choose the threshold for predictions, instead of using the classifier's default (0.50). In some examples, observations that are close to falling into class 0-say with a probability of 0.40-might make sense to include as a class 1 prediction so that a human operator could make the final decision on its inclusion for analysis. In some examples, mechanisms provided herein calibrate the model, or preserve the class distribution in the predicted probabilities, by rescaling the predictions after the prediction has been made by the underlying model. In some examples, logistic regression is a model that would not benefit from a calibration classifier since it already outputs probabilities.

In some examples, during modeling, a dataset may be split 80/20 training/testing. In some examples, a confusion matrix allows for comparison of a number of true and false positives and negatives for each class. A true positive (TP) occurs when an observation is predicted correctly in the class where it belongs. A false positive (FP) occurs when an observation is predicted as class 1 but actually belongs to class 0. A false negative (FN) occurs when an observation that is actually class 1 is predicted in class 0 by the model. A true negative (TN) is when an observation is predicted as class 0 and actually belongs in class 0. In some examples, “actually belonging” to a class means that this observation was labeled as such class in the training data.

The following equations for precision, recall, accuracy, and F1 Score can be used to create scores for model evaluation:

$$precision = \frac{T P}{T P + F P} ;$$

$$recall = \frac{T P}{T P + F N} ;$$

$$accuracy = \frac{T P + T N}{T P + T N + F P + F N} ; and$$

$$F 1 Score = 2 \times \frac{p r e c i s i o n \times r e c a l l}{p r e c i s i o n + r e c a l l} .$$

In some examples, an evaluation metric for modelling efforts includes the F1 score. In some examples, an F1 score is a harmonic mean of precision and recall. In some examples, the evaluation metric includes maximizing recall, thereby minimizing false negatives. In some examples, a goal of minimizing false negatives is creating a model to deploy into production to help subset a large number of content items crawled online for display in an analytical application. In some examples, a goal is to minimize false negatives, such as to let more content items that may be on the edge of class 1 be collected and further evaluated by human analysts.

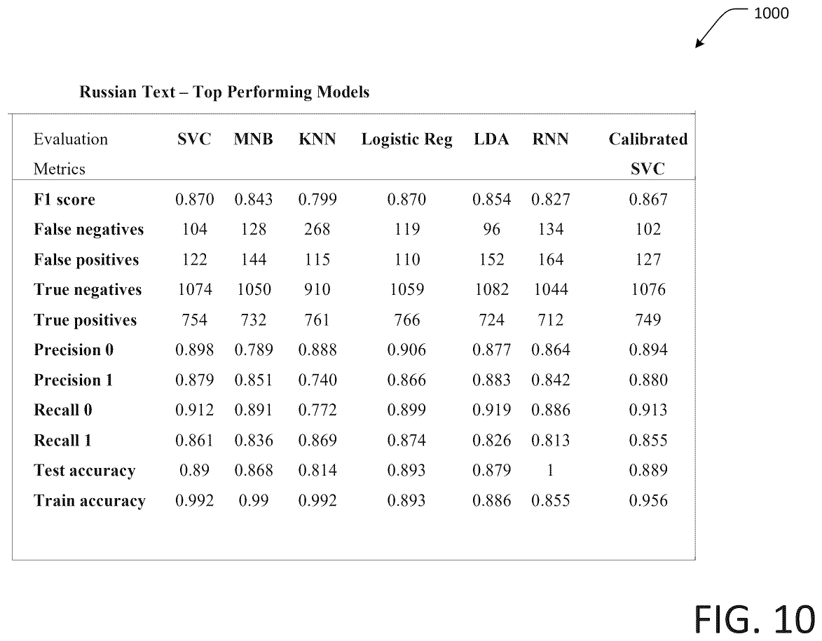

FIG. 10 illustrates an example table 1000 of evaluation metrics of Russian text (e.g., F1 score, precision, recall, accuracy), for various trained models (e.g., SVC, MNB, KNN, Logistical Regression, LDA, RNN, Calibrated SVC). According to the example table 1000, many of the models performed well. In the table 1000, the RNN has a test accuracy score of 1 (a perfect score), which may be due to the small sample size provided for testing each iteration. In table 1000, the RNN was a baseline experimental model to compare other models against, and time was not spent tuning/analyzing it. Further, in some examples, models benefit from calibration, such as SVC models, logistical regression models, and/or LDA models.

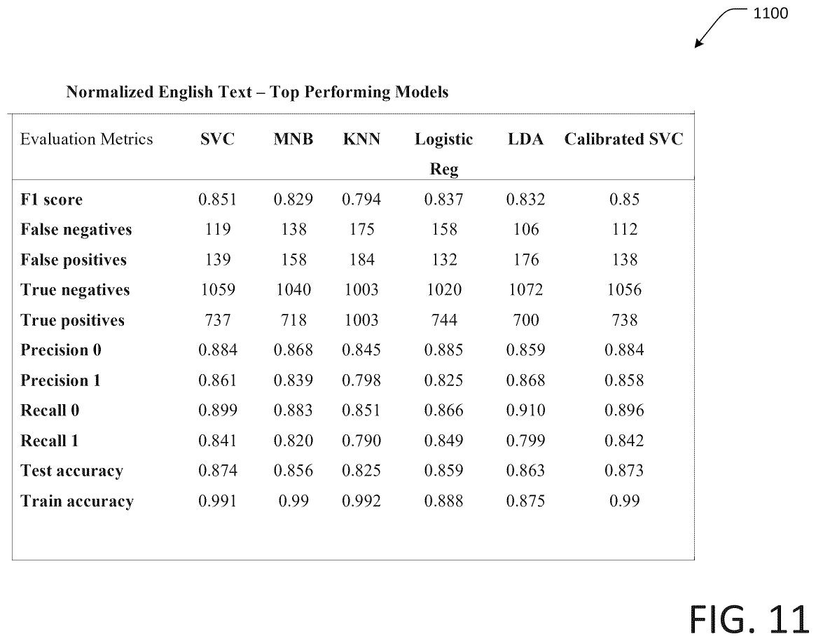

FIG. 11 illustrates an example table 1100 of evaluation metrics of normalized English text (e.g., F1 score, precision, recall, accuracy), for various trained models (e.g., SVC, MNB, KNN, Logistical Regression, LDA, Calibrated SVC). Further, in some examples, models benefit from calibration, such as SVC models, logistical regression models, and/or LDA models. In some examples, a calibrated SVC may be the candidate model. In some examples, the logistic regression and LDA models have better test vs train accuracy values than the calibrated SVC model. In some examples, the LDA model has the lowest number of false negatives. In some models, since the LDA models use topics as input, it is a larger, more complex model that takes three times longer to run than the SVC model. Further, in some examples, models benefit from calibration, such as SVC models, logistical regression models, and/or LDA models.

In some examples, mechanisms provided herein may use the calibrated SVC models for both Russian and normalized text. In some examples, the calibrated SVC models run quickly, are less computationally expensive, and/or their outputs are validated by domain experts. In some examples, using a calibrated version of models allows for adjustments to a threshold for inclusion in class 1. In some examples, model predictions are used as output natively.

In some examples, models trained according to aspects provided herein correctly classify between 85% and 91% of content items accurately. In some examples, between Sep. 27, 2021, and Dec. 29, 2022, 220,106 stories were classified as Russian master frames (e.g., associated with one or more predefined influence operations) from 14,239,761 stories received from at least one internet source. In some examples, the ability to analyze over 14 million stories automatically, using machine learning techniques provided herein, for a user to then visualize and quickly make decisions based thereon is a huge success. As a result, some benefits of mechanisms provided herein include using frame analysis of content items (e.g., Russian propaganda) to serve as a basis for reliable and accurate detection of influence operations and/or diverse narratives (e.g., Russian information warfare operations). For example, machine-learning models provided herein can show unique levels of reliability (e.g., high accuracy) and validity (e.g., explainability in context).

In some examples, advantages of mechanisms provided herein are enabled by the creation of a novel dataset of annotated content items, such as by domain experts performing content analysis, to train machine learning models that can be used to efficiently (e.g., quickly, on a large scale, etc.) detect and analyze influence operations from internet sources. In some examples, potential bias in the dataset provided herein is reduced by requiring labelers to inductively assess whether linguistic patterns of content items realize a pro-Russian propaganda frame, irrespective of the judgement of individuals as to a story's sentiment, veracity, or intention. Accordingly, some mechanisms provided herein provide for an analysis of content items based on linguistic framing, as opposed to sentiment analysis.

In some examples provided herein, a framework for measuring influence operations based on frame analysis are provided that can reliably detect and evaluate diverse narratives efficiently and at scale. In some examples, diagnostic and/or prognostic framing are central to influence operations, therefore allowing for frame analysis techniques provided herein to capture shifting operational objectives (e.g., narratives). Moreover, the performance of machine learning models provided herein for detecting influence operations (e.g., master frames) suggests framing can be used to detect influence operations accurately and at scale. Models for detecting influence operations and/or diverse narratives can be constructed in consideration of any country, government, agency, or organization, and in any language (e.g., mechanisms provided herein are not limited to detecting Russian propaganda).

Based on content analysis, the insights that could be gained from developing diverse narrative models should be recognized by those of ordinary skill in the art, at least in light of the examples provided herein. Detection grounded in recurring linguistic features pertinent to social mobilization (framing), such as rather than veracity of information, allows for accurate assessments on the amplification and effect of discrete frames and/or narratives.

Some mechanisms provided herein, which include supervised machine learning (ML) frameworks for analyzing influence operations online can be used with any language. In some examples, the supervised ML models can reliably identify stories with 85-91% accuracy. In some examples, mechanisms provided herein identify discrete diagnostic and prognostic communication frames in content items from at least one internet source, which in turn serve as training data for developing new machine learning models for detecting influence operations.

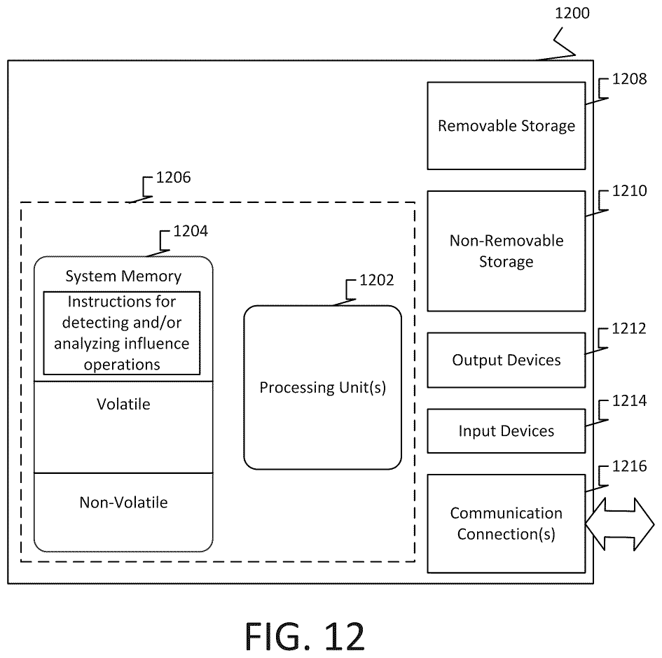

FIG. 12 illustrates a simplified block diagram of a device with which aspects of the present disclosure may be practiced in accordance with aspects of the present disclosure. The device may be a mobile computing device, for example. One or more of the present embodiments may be implemented in an operating environment 1200. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 1200 typically includes at least one processing unit 1202 and memory 1204. Depending on the exact configuration and type of computing device, memory 1204 (e.g., instructions for detecting and analyzing influence operations, as disclosed herein, etc.) may be volatile (such as RAM), non-volatile (such as ROM, flash memory, etc.), or some combination of the two. This most basic configuration is illustrated in FIG. 12 by dashed line 1206. Further, the operating environment 1200 may also include storage devices (removable, 1208, and/or non-removable, 1210) including, but not limited to, magnetic or optical disks or tape. Similarly, the operating environment 1200 may also have input device(s) 1214 such as remote controller, keyboard, mouse, pen, voice input, on-board sensors, etc. and/or output device(s) 1212 such as a display, speakers, printer, motors, etc. Also included in the environment may be one or more communication connections 1216, such as LAN, WAN, a near-field communications network, a cellular broadband network, point to point, etc.

Operating environment 1200 typically includes at least some form of computer readable media. Computer readable media can be any available media that can be accessed by the at least one processing unit 1202 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 1200 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

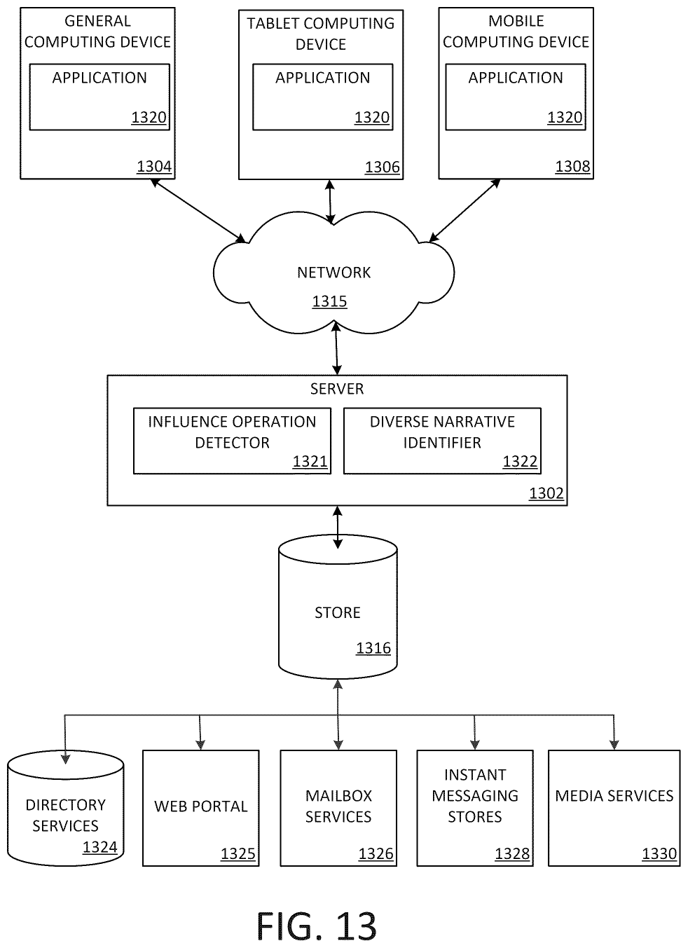

FIG. 13 illustrates one aspect of the architecture of a system for processing data received at a computing system from a remote source, such as a personal computer 1304, tablet computing device 1306, or mobile computing device 1308, as described above. Content displayed at server device 1302 may be stored in different communication channels or other storage types. For example, various documents may be stored using a directory service 1324, a web portal 1325, a mailbox service 1326, an instant messaging store 1328, or a media service 1330. The media service 1330 may include social media services (e.g., containing short-form and/or long-form content), print media services (e.g., newspapers, magazines, etc.) broadcast media services (e.g., radio, television, etc.), digital media services (e.g., blogs, podcasts, video platforms, etc.), and/or other forms of media used as communication for reaching and/or influencing an audience, as may be recognized by those of ordinary skill in the art.

An application 1320 (e.g., that contains or is configured to execute the instructions in the system memory 1200) may be employed by a client that communicates with server device 1302. Additionally, or alternatively, influence operation detector 1321 and/or diverse narrative identifier may be employed by server device 1302. The server device 1302 may provide data to and from a client computing device such as a personal computer 1304, a tablet computing device 1306 and/or a mobile computing device 1308 (e.g., a smart phone) through a network 1315. By way of example, the computer system described above may be embodied in a personal computer 1304, a tablet computing device 1306 and/or a mobile computing device 1308 (e.g., a smart phone). Any of these examples of the computing devices may obtain content from the store 1316, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for detecting influence operations, the method comprising:
receiving a plurality of content items from at least one internet source;
providing each content item of the plurality of content items to a primary machine-learning model, wherein the primary machine-learning model is trained to determine whether one or more content items are associated with one or more predefined influence operations;
receiving, from the primary machine-learning model, an indication that at least one content item of the plurality of content items is associated with the one or more predefined influence operations;
providing the at least one content item to at least one secondary machine-learning model, wherein the at least one secondary machine-learning model is trained to determine whether one or more content items are associated with one or more predefined diverse narratives for the one or more predefined influence operations;
receiving, from the at least one secondary machine-learning model, an indication of one or more predefined diverse narratives that are associated with one or more content items of the at least one content item; and
providing an output based on the indication of one or more predefined diverse narratives.

2. The method of claim 1, wherein the one or more predefined influence operations each correspond to a respective influence entity.

3. The method of claim 1, wherein the plurality of content items include one or more long-form content items.

4. The method of claim 1, wherein training the primary machine-learning model comprises:
aggregating a plurality of training content items;
labelling each training content item of the plurality of training content items to be associated with a respective one or more predefined or new influence operations; and
outputting the plurality of training content items with corresponding indications of the associated one or more predefined or new influence operations.

5. The method of claim 1, wherein training the at least one secondary machine-learning model comprises:
aggregating a plurality of training content items;
labelling each training content item of the plurality of training content items to be associated with a respective one or more predefined diverse narratives; and
outputting the plurality of training content items with corresponding indications of the associated one or more predefined diverse narratives.

6. The method of claim 1, wherein each predefined diverse narrative of the one or more predefined diverse narratives correspond to one or more selected from the group of: a diagnostic frame and a prognostic frame.

7. The method of claim 1, wherein, prior to providing the at least one content item to at least one secondary machine-learning model, the at least one content item is converted to text, and wherein the text is provided to the at least one secondary machine-learning model.

8. The method of claim 1, wherein, prior to providing each content item of the plurality of content items to a primary machine-learning model, a language of at least one content item of the plurality of content items is identified, and wherein the primary machine-learning model is selected from a plurality of machine-learning models, based on the identified language of the at least one content item.

9. A system for detecting influence operations, the system comprising:
a processor; and
memory storing instructions that, when executed by the processor, cause the system to perform a set of operations, the set of operations comprising:
receiving a plurality of content items from at least one internet source;
providing each content item of the plurality of content items to a primary machine-learning model, wherein the primary machine-learning model is trained to determine whether one or more content items are associated with one or more predefined influence operations;
receiving, from the primary machine-learning model, an indication that at least one content item of the plurality of content items is associated with the one or more predefined influence operations;
providing the at least one content item to at least one secondary machine-learning model, wherein the at least one secondary machine-learning model is trained to determine whether one or more content items are associated with one or more predefined diverse narratives for the one or more predefined influence operations;
receiving, from the plurality of narrative machine-learning models, an indication of one or more predefined diverse narratives that are associated with one or more content items of the at least one content item; and
providing an output based on the indication of one or more predefined diverse narratives.

10. The system of claim 9, wherein the one or more predefined influence operations each correspond to a respective influence entity.

11. The system of claim 9, wherein the plurality of content items include one or more long-form content items.

12. The system of claim 9, wherein training the primary machine-learning model comprises:
aggregating a plurality of training content items;
labelling each training content item of the plurality of training content items to be associated with a respective one or more predefined or new influence operations; and
outputting the plurality of training content items with corresponding indications of the associated one or more predefined or new influence operations.

13. The system of claim 9, wherein training the at least one secondary machine-learning model comprises:
aggregating a plurality of training content items;
labelling each training content item of the plurality of training content items to be associated with a respective one or more predefined diverse narratives; and
outputting the plurality of training content items with corresponding indications of the associated one or more predefined diverse narratives.

14. The system of claim 9, wherein each predefined diverse narrative of the one or more predefined diverse narratives correspond to one or more selected from the group of: a diagnostic frame and a prognostic frame.

15. The system of claim 9, wherein, prior to providing the at least one content item to at least one secondary machine-learning model, the at least one content item is converted to text, and wherein the text is provided to the at least one secondary machine-learning model.

16. The system of claim 9, wherein, prior to providing each content item of the plurality of content items to a primary machine-learning model, a language of at least one content item of the plurality of content items is identified, and wherein the primary machine-learning model is selected from a plurality of machine-learning models, based on the identified language of the at least one content item.

17. A method for identifying diverse narratives, the method comprising:
receiving a plurality of content items from at least one internet source;
providing at least one content item of the plurality of content items to a plurality of narrative machine-learning models, wherein the plurality of narrative machine-learning models are trained to determine whether one or more content items are associated with one or more predefined diverse narratives, wherein each predefined diverse narrative of the one or more predefined diverse narratives correspond to one or more selected from the group of: a diagnostic frame and a prognostic frame;
receiving, from the plurality of narrative machine-learning models, an indication of one or more predefined diverse narratives that are associated with one or more content items of the at least one content item; and
providing an output based on the indication of one or more predefined diverse narratives.

18. The method of claim 17, wherein training the plurality of narrative machine-learning models comprises:
aggregating a plurality of training content items;
labelling each training content item of the plurality of training content items to be associated with a respective one or more predefined diverse narratives; and
outputting the plurality of training content items with corresponding indications of the associated one or more predefined diverse narratives.

19. The method of claim 18, wherein, prior to providing the at least one content item to a plurality of narrative machine-learning models, the at least one content item is converted to text, and wherein the text is provided to the plurality of narrative machine-learning models.

20. The method of claim 19, wherein the plurality of content items include one or more long-form content items.
